(19) United States
(12) Patent Application Publication
(10) Pub. No.: US 2018/0070312 A1
(43) Pub. Date: Mar. 8, 2018

(54) WIRELESS COMMUNICATION METHOD AND SYSTEM

(71) Applicant: MediaTek Inc., Hsin-Chu (TW)

(72) Inventor: Chung-Wen TANG, Hsinchu City (TW)

(21) Appl. No.: 15/259,147

(22) Filed: Sep. 8, 2016

(51) Int. Cl. H04W 52/02; H04L 5/00

(52) U.S. Cl. CPC H04W 52/0225; H04L 5/0053

(57) ABSTRACT

A wireless communication method and device are provided. The wireless communication method includes the steps of using a transmitter to notify the receiver that a lane number, which is the number of active lanes, will be changed when the lane number will be changed; using the transmitter to transmit one control symbol to the receiver when the current data has been transmitted to the receiver; and using the transmitter to transmit new data to the receiver through the changed active lanes.

### BACKGROUND OF THE INVENTION

### Field of the Invention

The invention generally relates to a wireless communication technology, and more particularly, to a wireless communication method for changing the number of active lanes without needing to enter a save state.

### Description of the Related Art

In mobile communication system, as data-rate requirements become more stringent, it is becoming increasingly difficult for traditional I/Q interface between radio frequency (RF) and baseband (BB) to meet these requirements. One solution is to replace the I/Q interface with a Serializer/Deserializer (SerDes) interface. SerDes is a kind of high-speed serial data interface. A SerDes interface can consist of multiple lanes for very high data bandwidth requirements.

When the communication scenario is switched (e.g. in different communication environments), the data rate requirements also change. To optimize power savings, dynamically changing lane numbers is required. However, in mobile communication systems, real-time requirements are also a concern, even when the scenario changes, and so the lane change must take latency into careful consideration.

Based on mipi MPHY and UniPro specifications, both the transmitter (TX) and the receiver (RX) modules need to enter a save state before the lane configuration changes. That is to say, when the lane number will be changed, the TX and RX need to enter the save state in advance to prepare for the changing lane numbers to transmit new (next) data. For example, before the new data transmission, additional latency (including STALL, PREPARE and SYNC timing) will be generated. Therefore, the data transmission will need to be suspended when the TX and RX enter the save state. The long latency results in a poor user experience.

### BRIEF SUMMARY OF THE INVENTION

A wireless communication method and system are provided to overcome the problems mentioned above.

An embodiment of the invention provides a wireless communication method. The wireless communication method comprises the steps of notifying, using a transmitter, a receiver that a lane number, which is the number of active lanes, will be changed when the lane number will be changed; transmitting, using the transmitter, one or more control symbols to the receiver when the current data has been transmitted to the receiver; and transmitting, using the transmitter, new data to the receiver through the changed active lanes.

In some embodiments of the invention, when the lane number is increased the transmitter determines whether to notify the receiver by transmitting a command according to a state of a new lane which will be activated of the receiver. In some embodiments of the invention, when the transmitter needs to transmit the command to the receiver, the receiver activates the new lane after the receiver receives the command from the transmitter, and the transmitter transmits preamble signals to the receiver through the new lane. In some embodiments of the invention, when the transmitter does not need to transmit the command to the receiver, the transmitter transmits preamble signals to the receiver through the new lane.

In some embodiments of the invention, when the lane number is decreased, the transmitter transmits a command to the receiver to notify the receiver that lane number will be decreased when current data has been transmitted to the receiver. In these embodiments of the invention, the transmitter transmits the command along with the control symbols. In these embodiments of the invention, the transmitter transmits the control symbol to the receiver through a lane which will be closed before transmitting the new data to the receiver. In these embodiments of the invention, the transmitter transmits the control symbol to the receiver through one of the active lanes before transmitting the new data to the receiver. In these embodiments of the invention, the receiver closes an active lane which needs to be closed when receiving the control symbol and the transmitter transmits new data to the receiver through active lanes which do not include the closed lane.

In some embodiments of the invention, the transmitter transmits the command along with data to the receiver. In some embodiments of the invention, the transmitter transmits the command along with a sideband signal to the receiver.

An embodiment of the invention provides a wireless communication system. The wireless communication system includes a communication interface, a receiver and a transmitter. The communication interface comprises a plurality of lanes. The receiver is coupled to the communication interface. The transmitter, which is coupled to the communication interface, notifies the receiver that a lane number, which is the number of active lanes, will be changed, transmits one or more control symbols to the receiver when the current data has been transmitted to the receiver, and transmits new data to the receiver through the changed active lanes.

Other aspects and features of the invention will become apparent to those with ordinary skill in the art upon review of the following descriptions of specific embodiments of wireless communication methods and devices.

### BRIEF DESCRIPTION OF THE DRAWINGS

The invention will become more fully understood by referring to the following detailed description with reference to the accompanying drawings, wherein:

FIG. 1A is a block diagram of a communication system 100 according to an embodiment of the invention;

FIG. 1B is a block diagram of a communication system 200 according to an embodiment of the invention;

FIG. 2A is a timing diagram that illustrates the process for increasing the lane number according to an embodiment of the invention;

FIG. 2B is a timing diagram that illustrates the process for increasing the lane number according to another embodiment of the invention;

FIG. 3 is a timing diagram that illustrates the process for decreasing the lane number according to an embodiment of the invention;

FIG. 4 is a flow chart illustrating the wireless communication method for an increasing lane number according to an embodiment of the invention;

FIG. 5 is a flow chart illustrating the wireless communication method for a decreasing lane number according to an embodiment of the invention

FIG. 6 is a flow chart illustrating the wireless communication method for a decreasing lane number according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

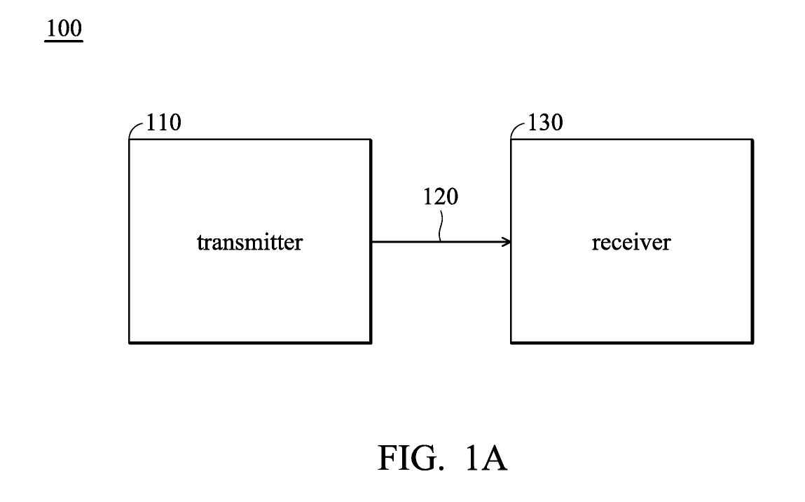

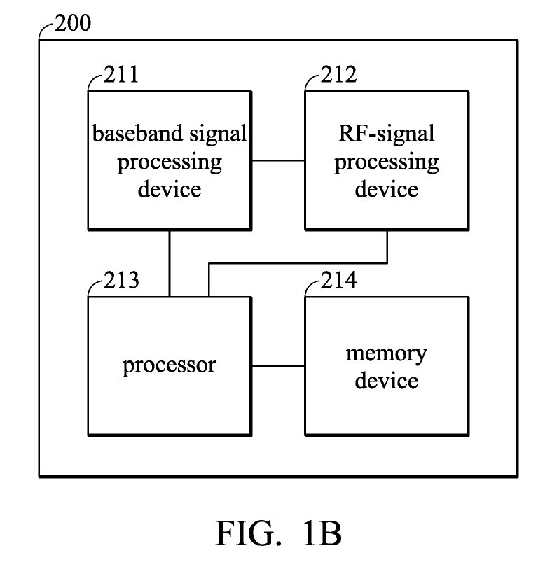

FIG. 1A is a block diagram of a communication system 100 according to an embodiment of the invention. The communication system 100 comprises a transmitter (TX) 110, a communication interface 120 and a receiver (RX) 130. Note that, in order to clarify the concept of the invention, FIG. 1A presents a simplified block diagram in which only the elements relevant to the invention are shown. However, the invention should not be limited to what is shown in FIG. 1A.

In the embodiments of the invention, the communication interface 120 may be a high-speed serial communication interface, such as a serializer/deserializer (SerDes). It should be noted that the transmitter 110 and receiver 130 may be devices which are configured to have both reception and transmission capabilities. However, to better focus on aspects of this disclosure, only the unidirectional transfer of information is shown.

In an embodiment of the invention, the transmitter 110 may be a radio frequency (RF) signal processing device and the receiver 130 may be a baseband signal processing device. In another embodiment of the invention, the transmitter 110 may be a baseband signal processing device and the receiver 130 may be a RF signal processing device. Details will be discussed in FIG. 1B below.

FIG. 1B is a block diagram of the communication system 200 according to an embodiment of the invention. In this embodiment of the invention, the communication system 200 can be regarded as the communication system 100, RF signal processing device 212 can be regarded as the transmitter 110 (or receiver 130) and the baseband signal processing device 211 can be regarded as the receiver 130 (or transmitter 110). As shown in FIG. 1B, communication system 200 comprise at least a baseband signal processing device 211, a RF signal processing device 212, a processor 213, a memory device 214, and an antenna module comprising at least one antenna. Note that, in order to clarify the concept of the invention, FIG. 1B presents a simplified block diagram in which only the elements relevant to the invention are shown. However, the invention should not be limited to what is shown in FIG. 1B.

The RF signal processing device 212 may receive RF signals via the antenna and process the received RF signals to convert the received RF signals to baseband signals to be processed by the baseband signal processing device 211, or receive baseband signals from the baseband signal processing device 211 and convert the received baseband signals to RF signals to be transmitted to a peer communications apparatus. The RF signal processing device 212 may comprise a plurality of hardware elements to perform radio frequency conversion. For example, the RF signal processing device 212 may comprise a power amplifier, a mixer, analog-to-digital conversion (ADC)/digital-to-analog conversion (DAC), etc.

The baseband signal processing device 211 may further process the baseband signals to obtain information or data transmitted by the peer communications apparatus. The baseband signal processing device 211 may also comprise a plurality of hardware elements to perform baseband signal processing. The baseband signal processing may comprise gain adjustment, modulation/demodulation, encoding/decoding, and so on. The baseband signal processing device 211 may also comprise a digital front end (DFE) module.

The processor 213 may control the operations of the baseband signal processing device 211 and the RF signal processing device 212. According to an embodiment of the invention, the processor 213 may also be arranged to execute the program codes of the software module(s) of the corresponding baseband signal processing device 211 and/or the RF signal processing device 212. The program codes accompanied by specific data in a data structure may also be referred to as a processor logic unit or a stack instance when being executed. Therefore, the processor 213 may be regarded as being comprised of a plurality of processor logic units, each for executing one or more specific functions or tasks of the corresponding software module(s).

The memory device 214 may store the software and firmware program codes, system data, user data, etc. of the communication system 200. The memory device 214 may be a volatile memory such as a Random Access Memory (RAM); a non-volatile memory such as a flash memory or Read-Only Memory (ROM); a hard disk; or any combination thereof.

According to an embodiment of the invention, the RF signal processing device 212 and the baseband signal processing device 211 may collectively be regarded as a radio module capable of communicating with a wireless network to provide wireless communications services in compliance with a predetermined Radio Access Technology (RAT). Note that, in some embodiments of the invention, the communication system 200 may be extended further to comprise more than one antenna and/or more than one radio module, and the invention should not be limited to what is shown in FIG. 1B.

In addition, in some embodiments of the invention, the processor 213 may be configured inside of the baseband signal processing device 211, or the communication system 200 may comprise another processor configured inside of the baseband signal processing device 211. Thus the invention should not be limited to the architecture shown in FIG. 1B.

In an embodiment of the invention, the communication interface 120 may comprise a plurality of lanes. The transmitter 110 may transmit data and control symbols to the receiver 130 through one or more lanes of the communication interface 120. That is to say, in some scenarios, the transmitter 110 may only use some of the lanes of the communication interface 120 to transmit data to the receiver 130 to save power. The lanes of the communication interface 120, utilized to transmit or receive data via the transmitter 110 and receiver 130, are regarded as the active lanes in the embodiments of the invention. The lane number can be regarded as the number of active lanes. The lane number is dynamically changed for different scenarios (e.g. in different communication environments) to satisfy different data transmission requirements.

In an embodiment of the invention, when the lane number will be changed (e.g. increased or decreased), the transmitter 110 may transmit a command to the receiver 130 to notify the receiver 130 that the lane number will be changed in advance. The receiver 130 can know that the lane number will be increased or decreased according to the command.

In an embodiment of the invention, when the command is transmitted to the receiver 130 in advance, the command may be transmitted along with the data. For example, the transmitter 110 may transmit the command (by using the command format specified in SerDes standard) with the data to the receiver 130 through the current active lanes. In this embodiment of the invention, when the receiver 130 receives the command, the receiver 130 may transmit an ACK signal to the transmitter 110 to notify the transmitter 110 that the command has been received accurately by the receiver 130. In another embodiment of the invention, when the command is transmitted to the receiver 130 in advance, the command may be transmitted along with the sideband signal (addition signals).

In another embodiment of the invention, when the lane number will be decreased, the command may be transmitted along with the control symbol(s) to the receiver 130. Namely, in this embodiment, the command may not need to be transmitted to the receiver 130 in advance.

In an embodiment of the invention, when the lane number will be increased, the transmitter 110 and the receiver 130 will activate (turn on) one or more new lanes (i.e. the new lane or lanes are not utilized for current data transmission) of the communication interface 120 for the data transmission requirement of the new data. Namely, when the receiver 130 receives the command and knows that the lane number will be increased according to the command, the receiver 130 may activate (turn on) one or more new lanes of the communication interface 120. Then the transmitter 110 may start to transmit the preamble signals to the receiver 130 through the new lane or lanes to do the synchronization of the new lane or lanes between the transmitter 110 and the receiver 130 for new (next) data transmission. In another embodiment of the invention, when the lane number will be increased and the new lane of the receiver 130 is in an STALL state, the transmitter 110 may not need to transmit the command to the receiver 130 in advance. Namely, the transmitter 110 may directly transmit the preamble signals to the receiver 130 through the new lane to notify the receiver 130 that the lane number will be changed in advance. However, if the new lane of the receiver 130 is in HIBERNATE state, the transmitter 110 must transmit the command to the receiver 130 in advance.

In the embodiments of the invention, the preamble signals may comprise different differential signals to indicate different lane states, such as DIF-Z, DIF-N and DIF-P. In addition, the preamble signals may be configured to indicate different states, such as STALL, PREPARE, and SYNC. In M-PHY standard specified by MIPI Alliance, DIF-Z means that no signal is driven in this lane (HIBERNATE state), DIF-N corresponds to STALL state (Power Saving State in HS-Mode), DIF-P corresponds to PREPARE state (the initial sub-state before the HS-burst state starts), and SYNC is followed by MKO symbol for boundary alignment. Therefore, the receiver 130 may do synchronization with the transmitter 110 and prepare for receiving new data according to the preamble signals.

When the current data has been transmitted to the receiver 130, the transmitter 110 will transmit one or more control symbols to the receiver 130 before transmitting the new data to the receiver 130 through the active lanes including the new lane or lanes. The receiver 130 can know when the receiver 130 needs to start to use the active lanes including the new lane or lanes to receive the new data and know the transmission order of the new data according to the control symbols. After the receiver 130 receives the control symbols through the active lanes including the new lane or lanes, the receiver 130 will start to receive new data from the transmitter 110 through the active lanes including the new lane or lanes. Accordingly, when the lane number will be increased, the transmitter 110 and the receiver 130 do not need to enter a save state (i.e. suspend the data transmission) before the lane configuration change. Note that, in the embodiments of the invention, the control symbols may be MKO specified in M-PHY standard, but the invention should not be limited to it. In the embodiments of the invention, the control symbols may be other symbol specified in other standards.

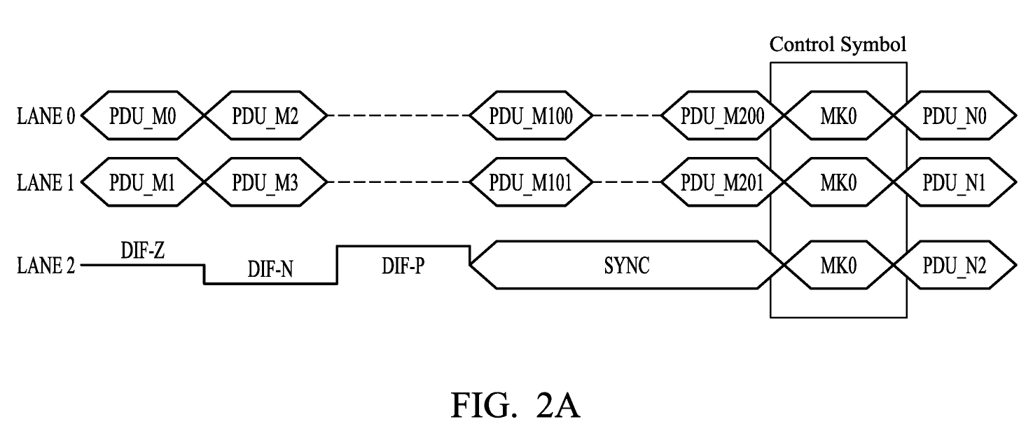

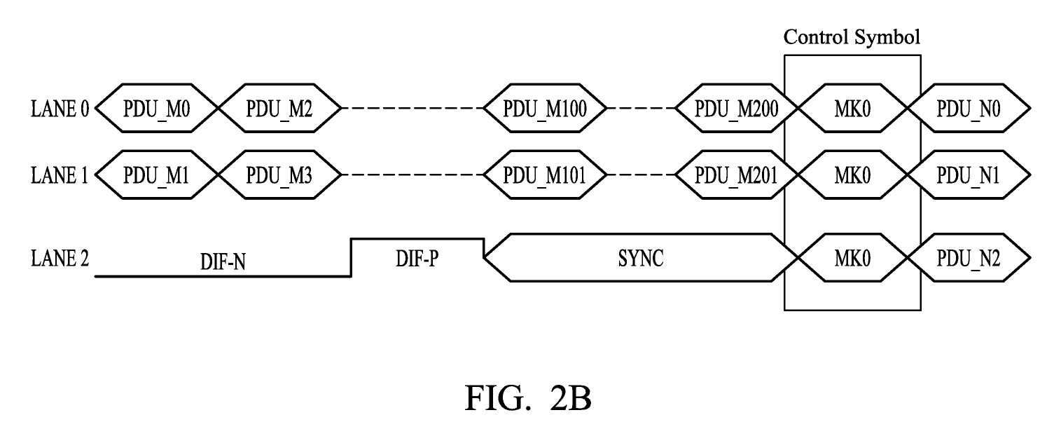

FIG. 2A is a timing diagram that illustrates the process for increasing the lane number according to an embodiment of the invention. FIG. 2A will be used as an example below for illustrating the above embodiments. As shown in FIG. 2A, the communication interface 120 comprises three lanes, LANE 0, LANE 1 and LANE 2. The transmitter 110 transmits the current data PDU_M0 . . . PDU_M201 to the receiver 130 through LANE 0 and LANE 1. When the number of active lanes needs to be increased for new data PDU_N (i.e. PDU_N0, PDU_N1 . . . ) and the lane of the receiver 130 which needs to be activated is in HIBERNATE state (i.e. the LANE 2 of the receiver 130 is in HIBERNATE state), the transmitter 110 may transmit the command to the receiver 130 to notify the receiver 130 that the lanes need to be increased (i.e. the LANE 2 needs to be activated for new data PDU_N). When the receiver 130 receives the command and knows that the lane number will be increased according to the command, the receiver 130 may activate LANE 2 and then the transmitter 110 may start to transmit the preamble signals, such as DIF-Z, DIF-N, DIF-P and SYNC, to the receiver 130. The receiver 130 may synchronize with the transmitter 110 and prepare for receiving new data according to the preamble signals.

FIG. 2B is a timing diagram that illustrates the process for increasing the lane number according to another embodiment of the invention. FIG. 2B will be used as an example below for illustrating the above embodiments. As shown in FIG. 2B, the communication interface 120 comprises three lanes, LANE 0, LANE 1 and LANE 2. The transmitter 110 transmits the current data PDU_M0 . . . PDU_M201 to the receiver 130 through LANE 0 and LANE 1. When the number of active lanes needs to be increased for new data PDU_N (i.e. PDU_NO, PDU_N1 . . . ) and the lane of the receiver 130 which needs to be activated is in STALL state (i.e. the LANE 2 of the receiver 130 is in STALL state), the transmitter 110 may directly transmit the preamble signals to the receiver 130 to notify the receiver 130 that the lanes need to be increased (i.e. the LANE 2 needs to be activated for new data PDU_N). The preamble signals include DIF-N, DIF-P and SYNC, to the receiver 130. The receiver 130 may synchronize with the transmitter 110 and prepare for receiving new data according to the preamble signals.

As shown in FIG. 2A and FIG. 2B when the current data has been transmitted to the receiver 130, the transmitter 110 will transmit control symbols MKO to the receiver 130 to indicate when the receiver 130 needs to use the active lanes (LANE 0, LANE 1 and LANE 2) to receive the new data PDU_N. The receiver 130 can know when the receiver 130 needs to start to use the LANE 0, LANE 1 and LANE 2 to receive the new data and know the transmission order of the new data according to the control symbols. After the receiver 130 receives the control symbols MKO through the LANE 0, LANE 1 and LANE 2, the receiver 130 will start to receive new data PDU_N from the transmitter 110 through the LANE 0, LANE 1 and LANE 2. Note that in FIG. 2A and FIG. 2B, the control symbols are MKO, but the invention should not be limited to MKO. For a different application, the control symbols may be other symbols.

When the lane number will be decreased, the receiver 130 may know that the lane number will be decreased according to the command. The transmitter 110 and the receiver 130 will close one or more current active lanes for the data transmission requirements of the new data to save power. Namely, the closed lane or lanes will enter a save state. When the lane number will be decreased, the command may be transmitted to the receiver 130 in advance or may be transmitted along with the control symbols to the receiver 130 by the transmitter 110.

When the current data has been transmitted to the receiver 130, the transmitter 110 will transmit one or more control symbols to the receiver 130 before transmitting the new data to the receiver 130 through the active lanes which do not include the closed lane(s). The receiver 130 can know when the receiver 130 needs to start to use the active lanes which do not include the closed lane(s) to receive the new data and know the transmission order of the new data according to the control symbol(s). After the receiver 130 receives the control symbol(s), the receiver 130 will start to receive new data from the transmitter 110 through the active lanes which do not include the closed lane(s). Accordingly, when the lane number will be decreased, the transmitter 110 and the receiver 130 do not need to enter a save state (i.e. suspend the data transmission) before the lane configuration change.

In an embodiment of the invention, when the lane number is decreased, the transmitter 110 may transmit the control symbol(s) to the receiver 130 through a lane (or lanes) which will be closed before transmitting the new data to the receiver 130 through the active lanes which do not include the closed lanes. That is to say, the active lane(s) which will not be closed can continuously transmit new data without receiving the control symbol(s).

In another embodiment of the invention, when the lane number is decreased, the transmitter 110 may transmit the control symbol(s) to the receiver 130 through all current active lanes before transmitting the new data to the receiver 130 through the active lanes which do not include the closed lanes.

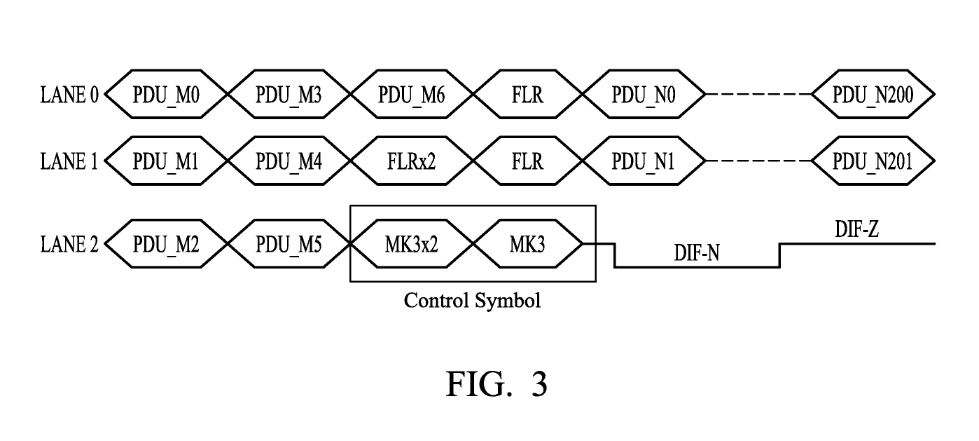

FIG. 3 is a timing diagram that illustrates the process for decreasing the lane number according to an embodiment of the invention. FIG. 3 will be used below as an example for illustrating the embodiments above. As shown in FIG. 3, the communication interface 120 comprises three lanes LANE 0, LANE 1 and LANE 2. The transmitter 110 transmits the current data PDU_M0 . . . PDU_M6 to the receiver 130 through LANE 0, LANE 1 and LANE 2. When the lane number needs to be decreased for new data PDU_N (i.e. PDU_N0 . . . PDU_N201), the transmitter 110 may transmit the command to the receiver 130 in advance or may transmit the command along with the control symbols to notify the receiver 130 that the lanes will need to be decreased (i.e. the LANE 2 needs to be closed). When the receiver 130 receives the command, the receiver can know that the lane number will be decreased according to the command. When the current data has been transmitted to the receiver 130, the transmitter 110 will transmit control symbols MK3×2 and MK3 to the receiver 130 to indicate when the receiver 130 needs to close some of the active lanes (i.e. lane 2 will be closed) before receiving the new data PDU_N. The receiver 130 can know when the receiver 130 needs to start to only use LANE 0 and LANE 1 to receive the new data and know the transmission order of the new data according to the control symbols. As shown in FIG. 0.3, the control symbol MK3 means the end of packet, and MK3×2 means two control symbols MK3. In addition, the symbol FLR means a blank packet (e.g. FILLER symbol specified in M-PHY standard), and the symbol FLR also can regarded one kind of control symbol.

After the receiver 130 receives the control symbols MK3, the receiver 130 will close LANE 2 (i.e. LANE 2 will enter the save state) and start to receive new data PDU_N from the transmitter 110 through the LANE 0 and LANE 1. Note that in FIG. 3, the control symbols are MK3, but the invention should not be limited to MK3 and FLR. For different applications, the control symbols may be other symbols. In addition, in FIG. 3, the control symbols are transmitted through LANE 0, LANE 1 and LANE 2, but the invention should not be so limited. The control symbols also can only be transmitted by the lane or lanes which will be closed.

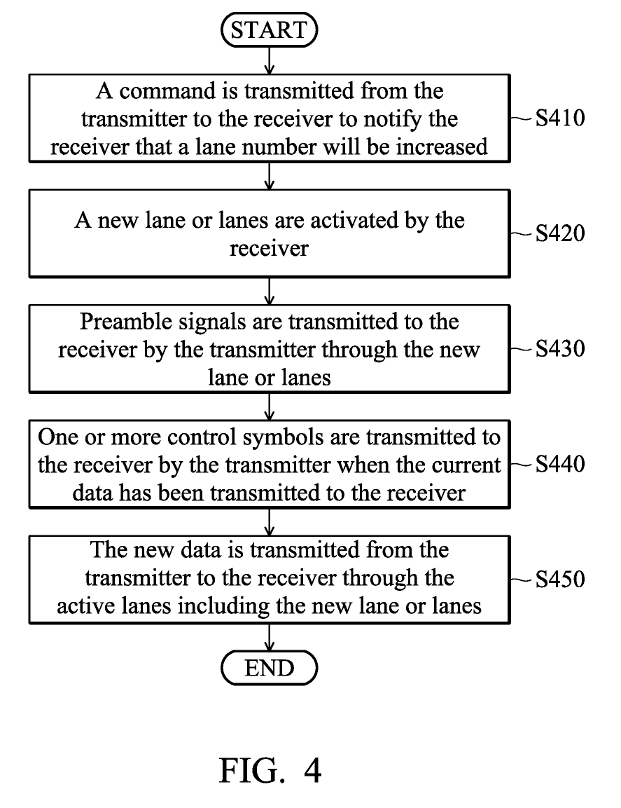

FIG. 4 is a flow chart illustrating the wireless communication method for an increasing lane number according to an embodiment of the invention. The wireless communication method is applied to the communication system 100. First, in step S410, a command is transmitted from the transmitter 110 to the receiver 130 to notify the receiver 130 that a lane number will be increased. In step S420, a new lane or lanes are activated by the receiver 130 after the receiver 130 receives the command from the transmitter 110. In step S430, preamble signals are transmitted to the receiver 130 by the transmitter 110 through the new lane or lanes. In step S440, one or more control symbols are transmitted to the receiver 130 by the transmitter 110 when the current data has been transmitted to the receiver 130. In step S450, the new data is transmitted from the transmitter 110 to the receiver 130 through the active lanes including the new lane or lanes.

In another embodiment of the invention, when the lane number will be increased and the new lane of the receiver 130 is in an STALL state, the transmitter 110 may not need to transmit the command to the receiver 130 in advance. Namely, steps S410 and S420 will not be performed in advance. However, if the new lane of the receiver 130 is in HIBERNATE state, the transmitter 110 still must transmit the command to the receiver 130 in advance.

In some embodiments of the invention, the command is transmitted along with data by the transmitter 110. In some embodiments of the invention, the command is transmitted along with a sideband signal by the transmitter 110.

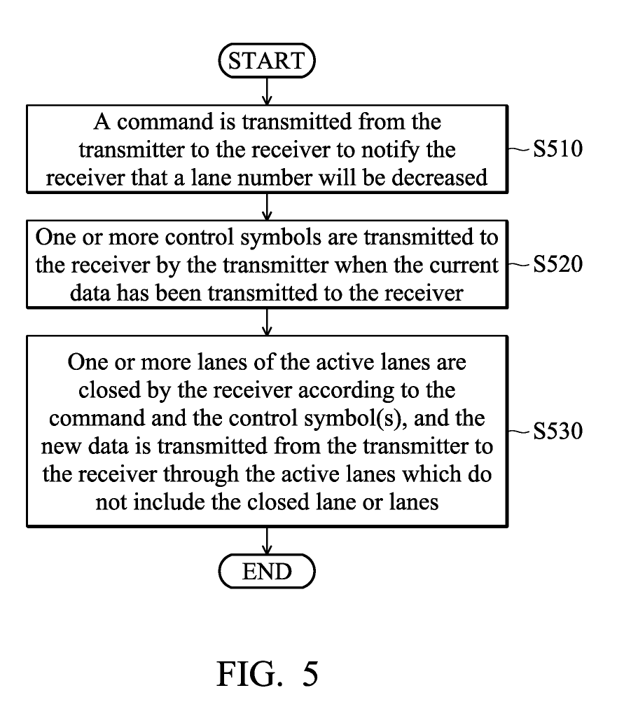

FIG. 5 is a flow chart illustrating the wireless communication method for a decreasing lane number according to an embodiment of the invention. The wireless communication method is applied to the communication system 100. First, in step S510, a command is transmitted from the transmitter 110 to the receiver 130 to notify the receiver 130 that a lane number will be decreased. In step S520, one or more control symbols are transmitted to the receiver 130 by the transmitter 110 when the current data has been transmitted to the receiver 130. In step S530, one or more lanes of the active lanes are closed by the receiver 130 according to the command and the control symbol(s) and the new data is transmitted from the transmitter 110 to the receiver 130 through the active lanes which do not include the closed lane or lanes.

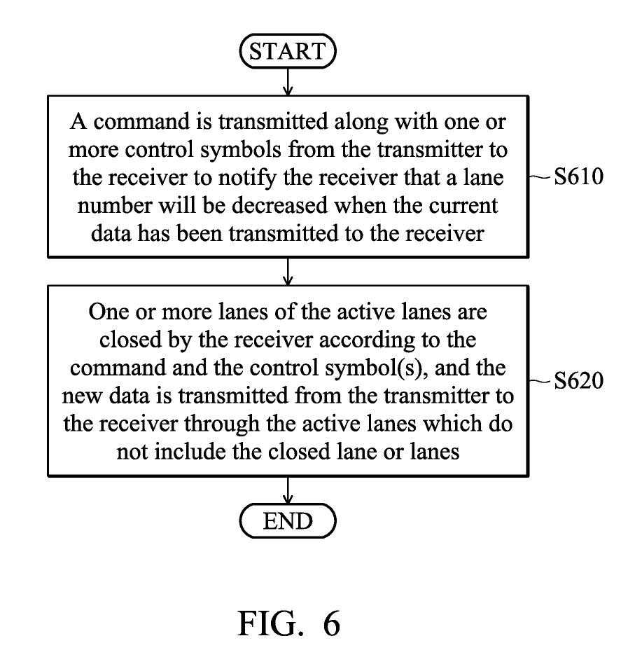

FIG. 6 is a flow chart illustrating the wireless communication method for a decreasing lane number according to another embodiment of the invention. The wireless communication method is applied to the communication system 100. First, in step S610, a command is transmitted along with one or more control symbols from the transmitter 110 to the receiver 130 to notify the receiver 130 that a lane number will be decreased when the current data has been transmitted to the receiver 130. In step S620, one or more lanes of the active lanes are closed by the receiver according to the command and the control symbol(s), and the new data is transmitted from the transmitter 110 to the receiver 130 through the active lanes which do not include the closed lane or lanes.

In some embodiments of the invention, when the lane number is decreased, the control symbols are transmitted to the receiver 130 through a lane or lanes which will be closed. In some embodiments of the invention, when the lane number is decreased, the control symbols are transmitted to the receiver 130 through all active lanes.

In the wireless communication method of the invention, when the lane number will be changed, the transmitter only needs to transmit the control symbol or symbols to notify the receiver when the receiver needs to start to use the changed active lanes (i.e. use the active lanes including the new lane or lanes or the active lanes which do not include the closed lanes) receiver data. Therefore, in the wireless communication method of the invention, when the lane number will be changed, the transmitter and receiver do not need to enter the save state first before lane configuration be changed. Namely, when the lane number will be changed, the data transmission will not be suspended because the transmitter and receiver need to enter the save state first. As a result, the latency for changing lane number will be decreased.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology can understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A wireless communication method, comprising:
notifying, by a transmitter, a receiver that a lane number of active lanes will be changed when the lane number of active lanes will be changed;
transmitting, by the transmitter, a control symbol to the receiver when current data has been transmitted to the receiver; and
transmitting, by the transmitter, new data to the receiver through changed active lanes.

2. The wireless communication method of claim 1, wherein when the lane number is increased, the wireless communication method further comprises:
determining, by the transmitter, whether to notify the receiver by transmitting a command according to a state of a new lane which will be activated of the receiver.

3. The wireless communication method of claim 2, wherein when the transmitter needs to transmit the command to the receiver, the wireless communication method further comprises:
activating, by the receiver, the new lane after the receiver receives the command from the transmitter; and
transmitting, by the transmitter, preamble signals to the receiver through the new lane.

4. The wireless communication method of claim 2, wherein when the transmitter does not need to transmit the command to the receiver, the wireless communication method further comprises:
transmitting, by the transmitter, preamble signals to the receiver through the new lane.

5. The wireless communication method of claim 1, wherein when the lane number is decreased, the wireless communication method further comprises:
transmitting, by the transmitter, a command to the receiver to notify the receiver that lane number will be decreased when current data has been transmitted to the receiver.

6. The wireless communication method of claim 5, further comprising:
transmitting, by the transmitter, the command along with the control symbols.

7. The wireless communication method of claim 5, further comprising:
transmitting, by the transmitter, the control symbol to the receiver through a lane which will be closed before transmitting the new data to the receiver.

8. The wireless communication method of claim 5, further comprising:
transmitting, by the transmitter, the control symbol to the receiver through one of the active lanes before transmitting the new data to the receiver.

9. The wireless communication method of claim 5, further comprising:
closing, by the receiver, an active lane which needs to be closed when receiving the control symbol; and
transmitting, by the transmitter, new data to the receiver through active lanes which do not include the closed lane.

10. The wireless communication method of claim 2, further comprising:
transmitting, by the transmitter, the command along with data to the receiver.

11. The wireless communication method of claim 2, further comprising:
transmitting, by the transmitter, the command along with a sideband signal to the receiver.

12. A wireless communication system, comprising:
a communication interface, comprising a plurality of lanes;
a receiver, coupled to the communication interface; and
a transmitter, coupled to the communication interface, notifying a receiver that a lane number of active lanes will be changed, transmitting a control symbol to the receiver when current data has been transmitted to the receiver, and transmitting new data to the receiver through changed active lanes.

13. The wireless communication system of claim 12, wherein when the lane number is increased, the transmitter determines whether to notify the receiver by transmitting a command according to a state of a new lane which will be activated of the receiver.

14. The wireless communication system of claim 13, wherein when the transmitter needs to transmit the command to the receiver, the receiver activates a new lane in the communication interface after the receiver receives the command from the transmitter and the transmitter transmits preamble signals to the receiver through the new lane.

15. The wireless communication system of claim 13, wherein when the transmitter does not need to transmit the command to the receiver, the transmitter transmits preamble signals to the receiver through the new lane.

16. The wireless communication system of claim 12, wherein when the lane number is decreased, the transmitter transmits a command to the receiver to notify the receiver that lane number will be decreased when current data has been transmitted to the receiver.

17. The wireless communication system of claim 16, the transmitter transmits the command along with the control symbols.

18. The wireless communication system of claim 16, wherein the transmitter transmits the control symbol to the receiver through a lane of the communication interface which will be closed before transmitting the new data to the receiver.

19. The wireless communication system of claim 16, wherein the transmitter transmits the control symbol to the receiver through one of the active lanes before transmitting the new data to the receiver.

20. The wireless communication system of claim 16, wherein the receiver closes an active lane which needs to be closed when receiving the control symbol and the transmitter transmits new data to the receiver through active lanes which do not include the closed lane.

21. The wireless communication system of claim 13, wherein the transmitter transmits the command along with data.

22. The wireless communication system of claim 13, wherein the transmitter transmits the command along with a sideband signal to the receiver.
